(19) United States
(12) Patent Application Publication
(10) Pub. No.: US 2009/0166593 A1
(43) Pub. Date: Jul. 2, 2009

(54) Antistatic Thermoplastic Resin Composition

(75) Inventors: Tae-Kyun KIM, Ansan-si (KR); Jong-Cheol LIM, Anyang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/345,903

(22) Filed: Dec. 30, 2008

(30) Foreign Application Priority Data
Dec. 31, 2007 (KR) 10-2007-0141913
Dec. 18, 2008 (KR) 10-2008-0129334

(51) Int. Cl. H01B 1/22; H01B 1/12

(52) U.S. Cl. 252/519.34; 252/519.33

(57) ABSTRACT

An antistatic thermoplastic resin composition includes a thermoplastic resin, an anionic antistatic agent, and a conductive metal oxide. The antistatic thermoplastic resin composition has enough antistatic properties to form various shapes of product, and it is particularly applicable for the production of housings of electro-electronic products or delivery trays for manufacturing an electro-electronic product.

### CROSS-REFERENCE TO RELATED APPLICATIONS

This application claims priority to and the benefit of Korean Patent Application No. 10-2007-0141913 filed in the Korean Intellectual Property Office on Dec. 31, 2007, and of Korean Patent Application No. 10-2008-0129334 filed in the Korean Intellectual Property Office on Dec. 18, 2008, the entire disclosure of each of which is incorporated herein by reference.

### FIELD OF THE INVENTION

The present invention relates to an antistatic thermoplastic resin composition.

### BACKGROUND OF THE INVENTION

Blends of polycarbonate and styrene copolymers can have good processability and notch impact strength and are used in the production of various products such as housings for electro-electronic products and injection molded products such as delivery trays for manufacturing electro-electronic products. However, such uses require antistatic properties to prevent damage to the electronic product due to static electricity.

An antistatic agent is generally added to the composition to provide the resin composition with antistatic properties. Examples of antistatic agents include nitrogen containing compounds such as amines, amide, quaternary ammonium salts, and the like, or sulfonic acid, aliphatic and aromatic sulfonium salts, or aliphatic and aromatic phosphonium salts. However, it can be difficult to achieve the desired antistatic properties of around 10⁵ to 10⁸ Ω/□(sq) using a single antistatic agent; furthermore, it is impossible to obtain higher antistatic properties that satisfy the requirements for the electro-electronic industry as it continues to develop.

U.S. Pat. Nos. 5,500,478 and 5,965,206 disclose methods of preparing an antistatic resin composition by using a polyether ester amide-based antistatic agent. However, the surface resistance that can be accomplished by using the antistatic agent is around 10¹⁰ to 10¹² Ω/□(sq). U.S. Pat. No. 5,010,139 discloses a method using an ethylene oxide-based antistatic agent. The surface resistance achieved, however, is around 10¹¹ to 10¹³ Ω/□(sq) at the most, which is insufficient to comply with electro-electronic antistatic requirements.

### SUMMARY OF THE INVENTION

An exemplary embodiment of the present invention provides an antistatic thermoplastic resin composition having excellent antistatic properties. The antistatic thermoplastic resin composition can have a surface resistance (Ω/□(sq)) of less than 10¹⁰, for example 10⁹ or less, as another example 10⁸ or less, as another example 10⁷ or less, and as yet another example 10⁶. Despite the reduced surface resistance, however, the articles can still exhibit desirable physical properties, such as impact strength. In exemplary embodiments, the articles can have an impact strength of at least about 20 kgf·cm/cm, for example at least about 30 kgf·cm/cm, as another example at least about 40 kgf·cm/cm, and as another example at least about 50 kgf·cm/cm, as determined in accordance with ASTM D256 (⅛″ sample, 23° C.).

Another embodiment of the present invention provides a molded product made using the antistatic thermoplastic resin composition.

The embodiments of the present invention are not limited to the above technical purposes, and a person of ordinary skill in the art can understand other technical purposes.

According to one embodiment of the present invention, an antistatic thermoplastic resin composition is provided that includes a thermoplastic resin, an anionic antistatic agent, and a conductive metal oxide.

According to another embodiment of the present invention, a molded product is provided that is made using the antistatic thermoplastic resin composition.

Hereinafter, further embodiments of the present invention will be described in detail.

The antistatic thermoplastic resin composition according to the present invention has excellent antistatic properties, so it can be useful for various articles. The antistatic thermoplastic resin of the invention can be particularly useful for the production of housings for electro-electronic products or delivery trays for manufacturing electro-electronic products.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” refers to one substituted with at least one substituent selected from halogen, C1 to C30 linear or branched alkyl, C1 to C30 haloalkyl, C3 to C30 cycloalkyl, C2 to C30 heterocycloalkyl, C6 to C30 aryl, C2 to C30 heteroaryl, C1 to C20 alkoxy, or a combination thereof.

As used herein, when a specific definition is not otherwise provided, the term “hetero” refers to one including at least one heteroatom selected from N, O, S, P, or a combination thereof, in place of a carbon atom.

The antistatic thermoplastic resin composition according to one embodiment of the present invention includes (A) a thermoplastic resin, (B) an anionic antistatic agent, and (C) a conductive metal oxide.

Exemplary components included in the antistatic thermoplastic resin composition according to embodiments of the present invention will hereinafter be described in detail. However, these embodiments are only exemplary, and the present invention is not limited thereto.

(A) Thermoplastic Resin

Non-limiting examples of the thermoplastic resin include polycarbonate resins, rubber modified vinyl-based graft copolymers, polystyrene-based resins, rubber modified polystyrene-based resins, nylon-based resins, vinyl-based copolymers, and combinations thereof.

(A-1) Polycarbonate Resin

The polycarbonate resin may be prepared by reacting diphenols of the following Formula 1 with phosgene, halogen formate, carbonate, or a combination thereof.

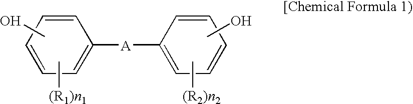

In the above Formula 1,

A is a single bond, substituted or unsubstituted C1 to C5 alkylene, substituted or unsubstituted C1 to C5 alkylidene, substituted or unsubstituted C3 to C6 cycloalkylene, substituted or unsubstituted C5 to C6 cycloalkylidene, CO, S, or SO₂,

R₁ and R₂ are each independently substituted or unsubstituted C1 to C30 alkyl or substituted or unsubstituted C6 to C30 aryl, and

n₁ and n₂ are each independently integers ranging from 0 to 4.

The diphenols represented by the above Formula 1 may be used in combinations to constitute a repeating unit of the polycarbonate resin. Exemplary diphenols useful in the present include without limitation hydroquinone, resorcinol, 4,4′-dihydroxydiphenyl, 2,2-bis-(4-hydroxyphenyl)-propane (referred to as “bisphenol-A”), 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and combinations thereof. In one exemplary embodiment, the diphenol can include 2,2-bis-(4-hydroxyphenyl)-propane, 2,2-bis-(3,5-dichloro-4-hydroxyphenyl)-propane, or 1,1-bis-(4-hydroxyphenyl)-cyclohexane, and in another exemplary embodiment, the biphenol can be 2,2-bis-(4-hydroxyphenyl)-propane.

In one embodiment, the polycarbonate resin can have an average molecular weight ranging from about 10,000 to about 200,000, and in another embodiment, the polycarbonate resin can have an average molecular weight ranging from about 15,000 to about 80,000, but the present invention is not limited thereto.

The polycarbonate resin may be a mixture of polycarbonate resins obtained using two or more diphenols that are different from each other. The polycarbonate resin may be a linear polycarbonate resin, a branched polycarbonate resin, a polyester carbonate copolymer, and the like, or a combination thereof.

The linear polycarbonate resin may include a bisphenol-A based polycarbonate resin. The branched polycarbonate resin may include one produced by reacting a multi-functional aromatic compound such as trimellitic anhydride, trimellitic acid, and the like with diphenols and carbonate. The multi-functional aromatic compound may be included in an amount of about 0.05 to about 2 mol % based on the total weight of the branched polycarbonate resin. The polyester carbonate copolymer resin may include one produced by reacting a difunctional carboxylic acid with diphenols and carbonate. The carbonate may include a diaryl carbonate such as diphenyl carbonate, and ethylene carbonate.

The antistatic thermoplastic resin of the invention can include the polycarbonate resin in an amount of about 45 to about 100 parts by weight, for example about 60 to about 100 parts by weight, based on 100 parts by weight of the (A) thermoplastic resin. When the polycarbonate resin is added in an amount of about 45 to about 100 parts by weight, it is possible to provide all of mechanical strength, impact resistance, and heat resistance.

(A-2) Rubber Modified Vinyl-Based Graft Copolymer

The rubber modified vinyl-based graft copolymer may be prepared by graft polymerizing about 5 to about 95 wt % of vinyl-based monomers to about 5 to about 95 wt % of a rubbery polymer.

Non-limiting examples of the vinyl-based monomer include about 50 to about 95 wt % of a first vinyl-based monomer including aromatic vinyl monomers such as styrene, α-C1 to C4 alkyl-substituted styrenes such as methylstyrene, and halogen-substituted styrenes, methacrylic acid C1 to C8 alkyl esters, acrylic acid C1 to C8 alkyl esters, and combinations thereof; and about 5 to about 50 wt % of a second vinyl-based monomer including acrylonitrile, methacrylonitrile, methacrylic acid C1 to C8 alkyl esters, acrylic acid C1 to C8 alkyl esters, maleic anhydride, C1 to C4 alkyl- or phenyl N-substituted maleimide, and combinations thereof.

Non-limiting examples of the rubbery polymer include butadiene rubber, acryl rubber, ethylene/propylene rubber, styrene/butadiene rubber, acrylonitrile/butadiene rubber, isoprene rubber, an ethylene-propylene-diene terpolymer (EPDM), a polyorganosiloxane/polyalkyl(meth)acrylate rubber composite, and combinations thereof.

The rubber modified vinyl-based graft copolymer may be used singularly or in combination.

Each methacrylic acid C1 to C8 alkyl ester or acrylic acid C1 to C8 alkyl ester is an alkyl ester of acrylic acid or methacrylic acid and may be obtained from a C2 to C8 monohydroxy alcohol.

Exemplary methacrylic acid C1 to C8 alkyl esters and acrylic acid C1 to C8 alkyl esters useful in the invention include without limitation methacrylic acid methyl ester, methacrylic acid ethyl ester, methacrylic acid propyl ester, methacrylic acid butyl ester, methacrylic acid pentyl ester, methacrylic acid hexyl ester, methacrylic acid heptyl ester, methacrylic acid octyl ester, acrylic acid methyl ester, acrylic acid ethyl ester, acrylic acid propyl ester, acrylic acid butyl ester, acrylic acid pentyl ester, acrylic acid hexyl ester, acrylic acid heptyl ester, acrylic acid octyl ester, and the like, and combinations thereof.

According to one embodiment, the rubber modified vinyl-based graft copolymer can be produced by graft copolymerizing styrene, acrylonitrile, and selectively a (meth)acrylic acid alkyl ester monomer to a butadiene rubber, an acryl rubber, or a styrene/butadiene rubber mixture.

According to another embodiment, the rubber modified vinyl-based graft copolymer can be produced by graft copolymerizing a monomer of (meth)acrylic acid methyl ester to a butadiene rubber, an acryl rubber, or a styrene/butadiene rubber.

The rubber modified vinyl-based graft copolymer may be prepared in accordance with conventional methods known to one having ordinary skill in this art, and the manufacturing method may include emulsion polymerization, suspension polymerization, solution polymerization, or bulk polymerization. According to one embodiment, the manufacturing method may include emulsion polymerization or bulk polymerization using a polymerization initiator and introducing the aromatic vinyl-based monomer in the presence of a rubber polymer.

The antistatic resin composition of the present invention can include the rubber modified vinyl-based graft copolymer in an amount of about 0 to about 30 parts by weight, for example about 0.1 to about 20 parts by weight, based on 100 parts by weight of the (A) thermoplastic resin. When the rubber modified vinyl-based graft copolymer is added within this range, it can provide advantages of impact resistance, chemical resistance, processing properties, and cost.

(A-3) Polystyrene or Rubber Modified Polystyrene Resin

The polystyrene resin may be prepared from an aromatic vinyl monomer using bulk polymerization, emulsion polymerization, or solution polymerization. Exemplary aromatic vinyl monomers useful in the present invention may include without limitation styrene, para methylstyrene, α-methyl styrene, 4-N-propyl styrene, and the like, and combinations thereof.

The rubber modified polystyrene resin according to the present invention can be enriched by grafting the aromatic vinyl monomer to a rubber. Exemplary rubbers useful in the present invention include without limitation butadiene, isoprene, 1,3-heptadiene, methyl-1,3-pentadiene, 2,3-dimethyl-1,3-butadiene, 2-ethyl-1,4-pentadiene, and combinations thereof. The rubber may be added in an amount of about 5 to about 15 wt % based on the total amount of the rubber modified polystyrene resin.

The polystyrene or rubber modified polystyrene resin may be prepared by suspension polymerization, emulsion polymerization, or continuous polymerization.

The polystyrene or rubber modified polystyrene resin can have a weight average molecular weight ranging from about 80,000 to about 400,000.

The antistatic thermoplastic resin composition of the invention can include polystyrene or rubber modified polystyrene resin in an amount of about 0 to about 70 parts by weight, for example about 0 to about 50 parts by weight, based on 100 parts by weight of the (A) thermoplastic resin. When the polystyrene or rubber modified polystyrene resin is present in an amount of about 0 to about 70 parts by weight, it can provide impact resistance and the mechanical strength.

(A-4) Nylon-Based Resin

Exemplary nylon-based resins useful in the present invention may be selected from, but are not limited to, commonly known polyamides such as nylon 6 that can be produced by ring-opening polymerizing lactam such as ε-caprolactam and ω-dodecalactam; nylon polymers that can be produced from an amino acid such as amino caproic acid, 11-amino undecanoic acid, 12-amino dodecanoic acid, and the like; nylon polymers that can be produced from an aliphatic, alicyclic, or aromatic diamine such as ethylene diamine, tetramethylene diamine, hexamethylene diamine, undecamethylene diamine, dodecamethylene diamine, 2,2,4-trimethylhexamethylene diamine, 2,4,4-trimethylhexamethylene diamine, 5-methylnonahexamethylene diamine, metaxylene diamine, paraxylene diamine, 1,3-bisaminomethyl cyclohexane, 1,4-bisaminomethyl cyclohexane, 1-amino-3-aminomethyl-3,5,5-trimethyl cyclohexane, bis(4-aminocyclohexane)methane, bis(4-methyl-4-aminocyclohexyl)methane, 2,2-bis(4-aminocyclohexyl)propane, bis(aminopropyl)piperazine, aminoethylpiperazine, and the like; aliphatic, alicyclic, or aromatic dicarbonic acids such as sebacic acid, azelaic acid, terephthalic acid, methyl phosphorous phthalic acid, 2-chloroterephthalic acid, 2-methylterephthalic acid, 5-methyl phosphorusphthalic acid, and the like; copolymer thereof; and combinations thereof.

Among these, the polyamide that is prepared by polymerizing adipic acid with hexamethylene diamine is called nylon 66.

According to one embodiment, the nylon-based resin is selected from nylon 6, nylon 66, or a copolymer thereof.

The nylon-based resin can have a relative viscosity ranging from about 2.4 to about 3.8 cp measured at a temperature of 25° C. with formic acid at 85%. When the relative viscosity of the nylon-based resin is within this range, it is possible to provide desirable mechanical strength such as impact resistance, and the resin can be useful for forming a shape, which can increase industrial efficiency.

The nylon-based resin can have a number-average molecular weight (Mn) ranging from about 20,000 to about 150,000, and the concentration of the amine terminal group can range from about 20 to about 60 mmol/kg.

The antistatic thermoplastic resin composition can include the nylon-based resin in an amount of about 0 to about 70 parts by weight, for example about 0 to about 50 parts by weight, based on 100 parts by weight of the (A) thermoplastic resin. When the nylon-based resin is added in an amount of about 0 to about 70 parts by weight, it can improve impact resistance, mechanical strength, and heat resistance.

(A-5) Vinyl-Based Copolymer

The vinyl-based copolymer can be prepared by copolymerizing about 50 to about 95 wt % of a first vinyl-based monomer including styrene, C1 to C4 alkyl-substituted styrenes such as α-methylstyrene, halogen-substituted styrenes, methacrylic acid C1 to C8 alkyl esters, acrylic acid C1 to C8 alkyl esters, and combinations thereof; and about 5 to about 50 wt % of a second vinyl-based monomer including acrylonitrile, methacrylonitrile, methacrylic acid C1 to C8 alkyl esters, acrylic acid C1 to C8 alkyl esters, maleic anhydride, C1 to C4 alkyl- or phenyl N-substituted maleimide, and combinations thereof.

Exemplary methacrylic acid C1 to C8 alkyl esters and acrylic acid C1 to C8 alkyl esters useful in the present invention include without limitation methacrylic acid methyl ester, methacrylic acid ethyl ester, methacrylic acid propyl ester, methacrylic acid butyl ester, methacrylic acid pentyl ester, methacrylic acid hexyl ester, methacrylic acid heptyl ester, methacrylic acid octyl ester, acrylic acid methyl ester, acrylic acid ethyl ester, methacrylic acid propyl ester, acrylic acid butyl ester, acrylic acid pentyl ester, acrylic acid hexyl ester, acrylic acid heptyl ester, acrylic acid octyl ester, and the like, and combinations thereof.

The vinyl-based copolymer may be generated as a by-product while preparing a rubber modified vinyl-based graft copolymer. For example, the vinyl-based copolymer can be generated when an excessive amount of vinyl-based monomer mixture is grafted to a small amount of rubbery polymer or when it includes an excessive amount of a chain transfer agent used as a molecular weight controlling agent.

According to one embodiment, the vinyl-based copolymer includes a monomer mixture of styrene, acrylonitrile, and selectively methacrylic acid methyl ester; a monomer mixture of α-methylstyrene, acrylonitrile, and selectively methacrylic acid methyl ester; or a monomer mixture of styrene, α-methylstyrene, acrylonitrile, and selectively methacrylic acid methyl ester. The vinyl-based copolymer can be prepared by emulsion polymerization, suspension polymerization, solution polymerization or bulk polymerization, and can have a weight-average molecular weight ranging from about 15,000 to about 300,000.

According to another embodiment, the vinyl-based copolymer may be prepared from a monomer mixture of methacrylic acid methyl ester monomer and selectively acrylic acid methyl ester. The vinyl-based copolymer may be prepared by emulsion polymerization, suspension polymerization, solution polymerization, or bulk polymerization, and can have a weight-average molecular weight ranging from about 20,000 to about 250,000.

According to a further embodiment, the vinyl-based copolymer is a copolymer of styrene and maleic anhydride, and it can be prepared by continuous bulk polymerization and solution polymerization. The composition ratio of the styrene and the maleic anhydride may be adjusted over a wide range, but in one embodiment, the amount of maleic anhydride is adjusted to about 5 to about 50 wt % based on the amount of vinyl copolymer. The styrene and maleic anhydride copolymer may have a wide-ranging molecular weight. According to one embodiment, the styrene and maleic anhydride copolymer may have a weight-average molecular weight ranging from about 20,000 to about 200,000 and an intrinsic viscosity ranging from about 0.3 to about 0.9.

In addition to α-methylstyrene, styrene monomers substituted with a C1 to C4 alkyl group capable of preparing the vinyl-based copolymer may include p-methylstyrene, vinyltoluene, 2,4-dimethylstyrene, and the like, and combinations thereof.

The vinyl-based copolymer may be used singularly or as a combination of two or more thereof.

The antistatic thermoplastic resin composition of the present invention may include the vinyl-based copolymer in an amount of about 0 to about 50 parts by weight, for example about 0 to about 40 parts by weight, based on 100 parts by weight of the (A) thermoplastic resin. When the vinyl-based copolymer is present in an amount of about 0 to about 50 parts by weight, it can provide compatibility, impact resistance, and heat resistance.

In one embodiment, the (A) thermoplastic resin includes a mixture of the (A-1) polycarbonate resin and the (A-2) rubber modified vinyl-based graft copolymer, and in another embodiment, the (A) thermoplastic resin includes a mixture of the (A-1) polycarbonate resin, the (A-2) rubber modified vinyl-based graft copolymer, and the (A-5) vinyl-based copolymer. When the (A-1) polycarbonate resin and the (A-2) rubber modified vinyl-based graft copolymer are used, the (A-1) polycarbonate resin can be present in an amount of about 45 to about 95 parts by weight and the (A-2) rubber modified vinyl-based graft copolymer can be present in an amount of about 1 to about 50 parts by weight, based on 100 parts by weight of a thermoplastic resin. When the (A-1) polycarbonate resin and the (A-2) rubber modified vinyl-based graft copolymer are added in the about amounts, they can provide compatibility, impact resistance, and heat resistance.

(B) Anionic Antistatic Agent

The anionic antistatic agent is represented by the following Formula 2.

CₙH₂ₙ₊₁—(R₈)ₘ—R₉⁻R₁₀⁺ [Chemical Formula 2]

In the above Formula 2,

R₈ is a linker including substituted or unsubstituted C1 to C5 alkylene, substituted or unsubstituted C5 to C6 cycloalkylene, substituted or unsubstituted C6 to C10 arylene, or substituted or unsubstituted C2 to C30 heteroarylene,

R₉⁻ comprises a sulfonic acid anion, a phosphonic acid anion, or a combination thereof,

R₁₀⁺ comprises an alkali metal cation, an alkaline-earth metal cation, or a combination thereof,

n is an integer ranging from 1 to 35, and

m is an integer ranging from 0 to 3.

In the above Formula 2, R₁₀⁺ may include a metal cation of sodium, potassium, calcium, lithium, barium, magnesium and the like, or a combination thereof.

The anionic antistatic agent may be used singularly or as a mixture of compounds having different n values. When a mixture of the anionic antistatic agents is used, it may include a copolymer in which the anionic antistatic agents having different n values in the form of a copolymer are copolymerized or a mixture in which the anionic antistatic agents having different n values in the form of a copolymer are simply mixed.

The antistatic thermoplastic resin composition of the present invention can include the anionic antistatic agent in an amount of about 0.1 to about 20 parts by weight, for example about 0.1 to about 10 parts by weight, and as another example about 1 to about 5 parts by weight, based on 100 parts by weight of the (A) thermoplastic resin When the anion-based antistatic agent is added in an amount of about 0.1 to about 20 parts by weight, it is possible to simultaneously accomplish excellent antistatic properties and excellent heat resistance and mechanical properties.

(C) Conductive Metal Oxide

Non-limiting examples of the conductive metal oxide include titanium oxide, zinc oxide, indium oxide, tin oxide, indium tin oxide, antimony oxide, zirconium oxide, aluminum oxide, magnesium oxide, barium oxide, calcium oxide, strontium oxide, chromium oxide, iron oxide, and the like and combinations thereof.

In addition, in order to improve the conductivity of the conductive metal oxide, the conductive metal oxide may be doped, coated, mixed, mechanically bound, or chemically bound with an element such as aluminum, gallium, germanium, indium, tin, and the like, or a combination thereof.

In addition, the conductive metal oxide may be formed into particles, fiber, thin film, amorphously, and the like.

Zinc oxide in the conductive metal oxide may be in a group state of basic constituting particles (primary particles), or a secondary coagulate state in which the basic constituting particles are fused and bound. According to one embodiment, it has a structure in which the secondary coagulate state is developed.

In addition, the zinc oxide can have a basic constituting particle having an average particle diameter of about 300 nm or less. According to one embodiment, the average particle diameter is about 200 nm or less, and in another embodiment, the average particle diameter ranges from about 10 to about 100 nm.

The antistatic thermoplastic resin composition of the invention can include the conductive metal oxide in an amount of about 0.1 to about 20 parts by weight, for example about 0.1 to 10 parts by weight, and as another example about 0.1 to about 5 parts by weight, based on 100 parts by weight of the (A) thermoplastic resin. When the conductive metal oxide is added in an amount of about 0.1 to about 20 parts by weight, it can simultaneously provide excellent antistatic properties, and excellent heat resistance and mechanical properties such as impact resistance.

(D) Other Additives

The antistatic thermoplastic resin composition according to the present invention may further include common additives such as antioxidants, flame retardants, lubricants, release agents, nuclear agents, thermal stabilizers, impact modifiers, inorganic additives, pigments, dyes, and the like, and combinations thereof, if required.

The antioxidant may include a phenol, phosphide, thioether, or amine antioxidant, or a combination thereof.

The flame retardant may be bromine-based, chlorine-based, phosphorous, metal hydroxy-based, and the like, or a combination thereof.

The thermal stabilizer may include trimethylphosphate, triphenylphosphate, triethylphosphate, phosphoric acid, and the like, or a combination thereof.

The release agent may include a fluorine-included polymer, silicon oil, a stearylic metal salt, a montanic metal salt, a montanic ester wax, or a polyethylene wax, and the like, or a combination thereof.

The inorganic additive may include asbestos, talc, ceramic, sulfate, and the like, or a combination thereof. The inorganic additive may be added in an amount of about 0 to about 60 parts by weight, for example about 1 to about 40 parts by weight, based on 100 parts by weight of the (A) thermoplastic resin of the present invention.

The antistatic thermoplastic resin composition according to the present invention may be prepared in accordance with known methods for preparing a resin composition. For example, it may be prepared by mixing the components of the antistatic thermoplastic resin composition according to one embodiment with other additives, and melt extruding the same in an extruder to provide a pellet.

The antistatic thermoplastic resin composition may be used in the production of various articles, and it is particularly applicable for housings for electro-electronic products or delivery trays for manufacturing electro-electronic products.

Hereinafter, the present invention is illustrated in more detail with reference to examples. However, they are exemplary embodiments of the present invention and are not limiting.

### EXAMPLES

### Preparing the Antistatic Thermoplastic Resin Composition

The following components are used to prepare the antistatic thermoplastic resin composition according to the present invention.

(A) The antistatic thermoplastic resin composition includes the following materials.

(1) Polycarbonate Resin

A bisphenol-A type of polycarbonate having a weight-average molecular weight (Mw) of 25,000.

(2) Rubber Modified Vinyl-Based Graft Copolymer

A butadiene rubber latex is added until the amount of butadiene reaches 58 parts by weight, and 29 parts by weight of styrene, 13 parts by weight of acrylonitrile, and 150 parts by weight of deionized water are added to provide a reactant. 1.0 part by weight of potassium oleate additive, 0.4 parts by weight of cumene hydroperoxide, and 0.3 parts by weight of a mercaptan-based chain transfer agent are added and reacted while the temperature is maintained at 75° C. for 5 hours to provide an ABS (acrylonitrile-butadiene-styrene) graft latex.

A sulfuric acid solution is added at 1 wt % based on the total amount of the obtained graft latex, and is solidified and dried to provide a rubber modified vinyl-based graft copolymer resin in a powder state.

(3) Polystyrene or Rubber Modified Polystyrene Resin

HG-1760S manufactured by Cheil Industries is used as a rubber modified polystyrene.

(4) Nylon-Based Resin

Nylon 6 TP-4210 manufactured by Zig Sheng (Taiwan) having a relative viscosity of 2.8 cp and a number-average molecular weight (Mn) of about 80,000 measured at a temperature of 25° C. while using 85% of formic acid.

(5) Vinyl-Based Copolymer

72 parts by weight of styrene, 28 parts by weight of acrylonitrile, and 120 parts by weight of deionized water are mixed to provide a reactant. 0.3 parts by weight of azobis isobutyronitrile, 0.2 parts by weight of a mercaptan-based chain transfer agent, and 0.5 parts by weight of tricalcium phosphate are added to the reactant, which is then suspension-polymerized to provide a SAN (styrene-acrylonitrile) copolymer resin. The copolymer resin is washed, dehydrated, and dried to provide a powdery SAN copolymer resin.

(B) Anionic Antistatic Agent

The anionic antistatic agent is commercially available under the trade name Hostastat HS-1® manufactured by Clariant.

(C) Conductive Metal Oxide

The conductive metal oxide is a conductive zinc oxide commercially available under the trade name 23-K® manufactured by Japan Hakusui Tech.

### Examples 1 to 4

Each component is introduced into a mixer in the amounts shown in the following Table 1 to provide a mixture. 0.2 parts by weight of a hindered phenol-based antioxidant (IRGANOX 1076) and 0.2 parts by weight of a pentaerythritol diphosphite-based thermostabilizer (DOVERPHOS S-9228) are added thereto based on 100 parts by weight of the mixture and mixed, and then extruded with a twin screw extruder having L/D=35, φ=45 mm to provide a pellet extrusion. The pellet is prepared into a sample with a 10 oz injector at an injecting temperature ranging from 240 to 280° C.

### Comparative Examples 1 to 5

Samples are prepared in accordance with the same procedure as in Example 1, except that each component and the amounts thereof are adjusted as shown in the following Table 1.

### Experimental Examples

The samples prepared in Examples 1 to 4 and Comparative Examples 1 to 5 are allowed to stand under conditions of 23° C. and relative humidity of 50% for 48 hours, and they are then evaluated to determine physical properties in accordance with the ASTM (American Society for Testing and Materials) standards.

A 10 cm×10 cm sample is evaluated by applying a voltage of 500V to determine the surface resistance with a surface resistance meter (manufactured by Mitsubishi Chemical, MCP-HT450) and a URS probe.

Notch izod impact strength is measured for a ⅛″ sample according to the ASTM D256 standard.

The appearance of the samples is assessed based upon the number of silver streaks generated on a 10 cm×10 cm injection sample: none found is determined as “good”; 1 to 3 parts generated is determined as “poor”; and more than 3 parts generated is determined as “very poor.”

The results are shown in the following Table 1.

TABLE 1

| | | Examples | | | | Comparative Examples | | | | |
|---|---|---|---|---|---|---|---|---|---|---|
| | | 1 | 2 | 3 | 4 | 1 | 2 | 3 | 4 | 5 |
| (A) | (1) Polycarbonate resin | 60 | 60 | 60 | 60 | 60 | 60 | 60 | 60 | |
| Thermoplastic | (parts by weight) | | | | | | | | | |
| resin | (2) Rubber modified | 10 | 10 | | | 10 | 10 | 10 | 10 | |
| | vinyl-based graft | | | | | | | | | |
| | copolymer (parts by | | | | | | | | | |
| | weight) | | | | | | | | | |
| | (3) Polystyrene or | — | — | 40 | | — | — | — | — | 100 |
| | rubber modified | | | | | | | | | |
| | polystyrene resin | | | | | | | | | |
| | (parts by weight) | | | | | | | | | |
| | (4) Nylon-based resin | — | — | | 40 | — | — | — | — | |
| | (parts by weight) | | | | | | | | | |
| | (5) Vinyl-based | 30 | 30 | | | 30 | 30 | 30 | 30 | |
| | copolymer | | | | | | | | | |
| | (parts by weight) | | | | | | | | | |

| | | | | | | | | | |
|---|---|---|---|---|---|---|---|---|---|
| (B) Anionic antistatic agent | 5 | 5 | 5 | 5 | 0.5 | 3 | 10 | — | 5 |
| (parts by weight) | | | | | | | | | |
| (C) Conductive metal oxide | 0.5 | 1 | 1 | 1 | — | — | — | 1 | 40 |
| (parts by weight) | | | | | | | | | |
| Surface resistance (Ω/□(sq)) | 10⁷ | 10⁶ | 10⁶ | 10⁶ | 10¹⁶ | 10¹⁰ | 10¹⁰ | 10¹⁶ | 10⁷ |
| Impact Strength (⅛″) | 40 | 30 | 30 | 30 | 50 | 40 | 10 | 35 | 3 |
| (23° C., kgf · cm/cm) | | | | | | | | | |
| Appearance Assessment | Good | Good | Good | Good | Good | Good | Good | Good | Good |

As shown in Table 1, Examples 1 to 4 of the present invention exhibit a surface resistance ranging from 10⁶ to 10⁷ Ω/□(sq). In contrast, Comparative Example 1 which includes only a small amount of anionic antistatic agent does not exhibit decreased surface resistance at all; and Comparative Example 4 which includes only a conductive metal oxide also does not exhibit decreased surface resistance at all.

Comparative Examples 2 and 3 which include only the anionic antistatic agent exhibit a decrease in surface resistance to only 10¹⁰ Ω/□(sq); in addition, Comparative Example 3 exhibits substantially deteriorated impact strength.

Comparative Example 5 which includes conductive metal oxide in an amount greater than the compositions of the invention has a similar surface resistance as Examples 1 to 4. However, Comparative Example 5 exhibits substantially deteriorated impact strength.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An antistatic thermoplastic resin composition comprising
(A) about 100 parts by weight of a thermoplastic resin;
(B) about 0.1 to about 20 parts by weight of an anionic antistatic agent; and
(C) about 0.1 to about 20 parts by weight of a conductive metal oxide.

2. The antistatic thermoplastic resin composition of claim 1, wherein the thermoplastic resin (A) comprises a polycarbonate resin, a rubber modified vinyl-based graft copolymer, polystyrene, a rubber modified polystyrene resin, a nylon-based resin, a vinyl-based copolymer, or a combination thereof.

3. The antistatic thermoplastic resin composition of claim 1, wherein the thermoplastic resin (A) comprises about 45 to about 95 parts by weight of a polycarbonate resin and about 1 to about 50 parts by weight of a rubber modified vinyl-based graft copolymer based on about 100 parts by weight of the thermoplastic resin (A).

4. The antistatic thermoplastic resin composition of claim 1, wherein the thermoplastic resin (A) is a polycarbonate resin.

5. The antistatic thermoplastic resin composition of claim 1, comprising the anionic antistatic agent (B) in an amount of about 0.1 to about 10 parts by weight based on about 100 parts by weight of the thermoplastic resin (A).

6. The antistatic thermoplastic resin composition of claim 1, comprising the conductive metal oxide (C) in an amount of about 0.1 to about 10 parts by weight based on about 100 parts by weight of the thermoplastic resin (A).

7. The antistatic thermoplastic resin composition of claim 2, wherein the polycarbonate resin comprises the reaction product of a diphenol of the following Formula 1 with a compound of phosgene, halogen formate, carbonate, or a combination thereof: 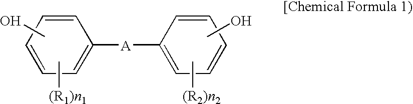
wherein, in the above Formula 1,
A is a single bond, substituted or unsubstituted C1 to C5 alkylene, substituted or unsubstituted C1 to C5 alkylidene, substituted or unsubstituted C3 to C6 cycloalkylene, substituted or unsubstituted C5 to C6 cycloalkylidene, CO, S, or SO₂,
R₁ and R₂ are each independently substituted or unsubstituted C1 to C30 alkyl or substituted or unsubstituted C6 to C30 aryl, and
n₁ and n₂ are each independently integers ranging from 0 to 4.

8. The antistatic thermoplastic resin composition of claim 2, wherein the rubber modified vinyl-based graft copolymer is obtained by graft polymerization of about 5 to about 95 wt % of vinyl-based monomers to about 5 to about 95 wt % of a rubbery polymer,
wherein the vinyl-based monomers comprise about 50 to about 95 wt % of a first vinyl-based monomer comprising styrene, an α-C1 to C4 alkyl-substituted styrene, a halogen-substituted styrene, a methacrylic acid C1 to C8 alkyl ester, an acrylic acid C1 to C8 alkyl ester or a combination thereof; and about 5 to about 50 wt % of a second vinyl-based monomer comprising acrylonitrile, methacrylonitrile, a methacrylic acid C1-C8 alkyl ester, an acrylic acid C1 to C8 alkyl ester, maleic anhydride, a C1 to C4 alkyl- or phenyl N-substituted maleimide, or a combination thereof, and
wherein the rubbery polymer comprises butadiene rubber, acryl rubber, ethylene/propylene rubber, styrene/butadiene rubber, acrylonitrile/butadiene rubber, isoprene rubber, an ethylene-propylene-diene terpolymer (EPDM), a polyorganosiloxane/polyalkyl(meth)acrylate rubber composite, or a combination thereof.

9. The antistatic thermoplastic resin composition of claim 2, wherein the polystyrene resin is obtained by polymerization of an aromatic vinyl monomer comprising styrene, para methylstyrene, α-methyl styrene, 4-N-propyl styrene, or a combination thereof,
the rubber modified polystyrene resin is obtained by graft polymerization of an aromatic vinyl monomer comprising styrene, para methylstyrene, α-methyl styrene, 4-N-propyl styrene, or a combination thereof to a rubber comprising butadiene, isoprene, 1,3-heptadiene, methyl-1,3-pentadiene, 2,3-dimethyl-1,3-butadiene, 2-ethyl-1,4-pentadiene, or a combination thereof.

10. The antistatic thermoplastic resin composition of claim 2, wherein the nylon-based resin comprises nylon 6, nylon 66, a copolymer thereof, or a combination thereof.

11. The antistatic thermoplastic resin composition of claim 2, wherein the vinyl-based copolymer is obtained from copolymerization of:
about 50 to about 95 wt % of a first vinyl-based monomer comprising styrene, an α-C1 to C4 alkyl-substituted styrene, a halogen-substituted styrene, a methacrylic acid C1 to C8 alkyl ester, an acrylic acid C1 to C8 alkyl ester, or a combination thereof; and
about 5 to about 50 wt % of a second vinyl-based monomer comprising acrylonitrile, methacrylonitrile, a methacrylic acid C1 to C8 alkyl ester, an acrylic acid C1 to C8 alkyl ester, maleic anhydride, a C1 to C4 alkyl- or phenyl N-substituted maleimide, or a combination thereof.

12. The antistatic thermoplastic resin composition of claim 1, wherein the anionic antistatic agent (B) is represented by the following Formula 2:
CₙH₂ₙ₊₁—(R₈)ₘ—R₉⁻R₁₀⁺ [Chemical Formula 2]
wherein, in the above Formula 2,
R₈ is a linker comprising substituted or unsubstituted C1 to C5 alkylene, substituted or unsubstituted C5 to C6 cycloalkylene, substituted or unsubstituted C6 to C10 arylene, or substituted or unsubstituted C2 to C30 heteroarylene,
R₉⁻ comprises a sulfonic acid anion, a phosphonic acid anion, or a combination thereof,
R₁₀⁺ comprises a cation of an alkali metal, an alkaline-earth metal, or a combination thereof,
n is an integer ranging from 1 to 35, and
m is an integer ranging from 0 to 3.

13. The antistatic thermoplastic resin composition of claim 1, wherein the conductive metal oxide (C) comprises titanium oxide, zinc oxide, indium oxide, tin oxide, indium tin oxide, antimony oxide, zirconium oxide, aluminum oxide, magnesium oxide, barium oxide, calcium oxide, strontium oxide, chromium oxide, iron oxide, or a combination thereof.

14. The antistatic thermoplastic resin composition of claim 13, wherein the conductive metal oxide (C) further comprises aluminum, gallium, germanium, indium, tin, or a combination thereof.

15. The antistatic thermoplastic resin composition of claim 1, wherein the thermoplastic resin composition has a surface resistance of less than 10¹⁰ Ω/□(sq).

16. The antistatic thermoplastic resin composition of claim 1, wherein the thermoplastic resin composition has a surface resistance of 10⁹ Ω/□(sq) or less.

17. The antistatic thermoplastic resin composition of claim 1, wherein the thermoplastic resin composition has a surface resistance of 10⁸ Ω/□(sq) or less.

18. The antistatic thermoplastic resin composition of claim 15, wherein the thermoplastic resin composition has an impact strength of at least about 20 kgf·cm/cm, as determined in accordance with ASTM D256 (⅛″ sample, 23° C.).

19. The antistatic thermoplastic resin composition of claim 15, wherein the thermoplastic resin composition has an impact strength of at least about 30 kgf·cm/cm, as determined in accordance with ASTM D256 (⅛″ sample, 23° C.).

20. A molded product made using the antistatic thermoplastic resin composition according to claim 1.
